(19) United States
(12) Patent Application Publication
(10) Pub. No.: US 2023/0302656 A1
(43) Pub. Date: Sep. 28, 2023

(54) Visual-Tactile Sensing Device for Use in Robotic Gripper

(71) Applicant: ABB Schweiz AG, Baden (CH)

(72) Inventor: Nolan W. Nicholas, West Lafayette, IN (US)

(73) Assignee: ABB Schweiz AG, Baden (CH)

(21) Appl. No.: 18/018,793

(22) PCT Filed: Jul. 30, 2020
(86) PCT No.: PCT/US2020/044213

§ 371 Date: Jan. 30, 2023

(51) Int. Cl. B25J 13/08; B25J 19/02

(52) U.S. Cl. CPC B25J 13/084; B25J 19/023

(57) ABSTRACT

A visual-tactile sensing device includes a visual-tactile sensing pad useful to capture image data related to a work piece during contact with the pad and as it approaches the pad. The sensing device can be used as part of a robotic gripper or other device. One or more lights can be used to illuminate the work piece and/or project light through the pad. The pad includes a rigid base, an elastic layer structured to deform upon contact with the work piece, a light layer 70 structured to emit light at a first wavelength, and a spectrally absorbing layer structured to absorb light at a target wavelength but allow light at other wavelengths to pass. In one form the light layer can be a fluorescent layer. The spectrally absorbing layer can be a dye layer.

### TECHNICAL FIELD

The present disclosure generally relates to visual-tactile sensing devices, and more particularly, but not exclusively, to robotic grippers that incorporate visual-tactile sensing devices.

### BACKGROUND

Providing tactile information of a work piece derived from image data generated with a visual-tactile sensing pad along with proximity information of a work piece prior to engagement with the pad remains an area of interest. Some existing systems have various shortcomings relative to certain applications. Accordingly, there remains a need for further contributions in this area of technology.

### SUMMARY

One embodiment of the present disclosure is a unique visual-tactile sensing pad. Other embodiments include apparatuses, systems, devices, hardware, methods, and combinations for determining tactile information and proximity of work piece to a sensing device. Further embodiments, forms, features, aspects, benefits, and advantages of the present application shall become apparent from the description and figures provided herewith.

### BRIEF DESCRIPTION OF THE FIGURES

FIG. 1 depicts an embodiment of a visual-tactile sensing device in proximity to a work piece.

FIG. 2 depicts an embodiment of a visual-tactile contact pad.

FIG. 3 depicts another embodiment of a visual-tactile contact pad.

FIG. 4 depicts another embodiment of a visual-tactile contact pad.

FIG. 5 depicts another embodiment of a visual-tactile contact pad.

FIG. 6 depicts another embodiment of a visual-tactile contact pad.

### DETAILED DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

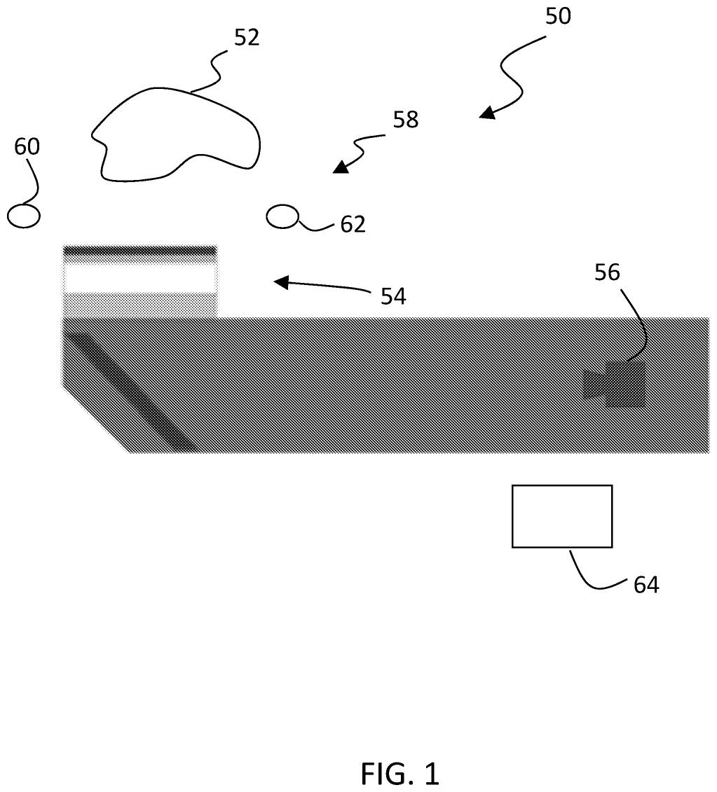

With reference to FIG. 1, a visual-tactile sensing device 50 is illustrated and is useful for sensing a work piece 52 as it approaches and eventually contacts a visual-tactile contact pad 54 of the device 50. The visual-tactile contact pad 54 is made of a number of pliable layers which deform when contacted under force by the work piece 52. Deformation of the pad 54 causes a change in light coming from the pad 54 which can be sensed by the camera 56. Aiding the camera in detecting light changes is a lighting system 58 which in the illustrated embodiment includes a first light source 60 and a second light source 62 but will be understood to include any different number of light sources. Although the camera is depicted as being displaced from the pad 54 it will be appreciated that it can be placed in other locations. Further, the lights of the lighting system 58 are shown as being displaced to the side of the pad 54 and/or imaging scene of the camera 56, but other locations are also contemplated herein. A controller 64 can be included to regulate actions of the lighting system 58, the camera 56, and/or a device used to change position or orientation of the work piece 52. For example, in some forms the visual-tactile sensing device can be incorporated into a robotic system in which a gripper or the like is formed to include the pad 54. The controller 64 can alternatively and/or additionally be used to estimate contours of the work piece 52 and/or forces used to impress the work piece into the pad 54. Embodiments will be described below with respect to the pad 54 and various different characteristics, but it will be appreciated that all can be incorporated into the embodiments discussed with respect to FIG. 1.

In more specific details, the present application provides for the use of a tactile sensor possessing a deformable surface structure wherein the deformation of the surface structure by contacting objects may be imaged by a proximate camera and wherein images may also be obtained through this surface structure to observe objects and features which are not in contact with the surface layer. Typically the deformable surface structure (e.g. the pad 54) will be substantially transparent and possess a coating at or near its surface which is reflective and possesses known optical characteristics so that the shape of this surface layer may be imaged directly without complication from unknown optical characteristics. This provides the system the ability to both sense objects in contact with the sensing surface and forces resulting therefrom and also the ability to sense objects and features that are beyond the surface of the sensor body. This enables enhanced sensing for applications such as robotic manipulation, metrology and surface measurement and characterization.

In the embodiments disclosed herein a sensor can be constructed utilizing a layer of deformable material possessing a top-coat which is substantially reflective for incident lighting with certain properties and substantially light-transmitting for incident lighting with different properties and a camera and lighting system which is placed behind this layer. When objects (e.g. the work piece 52) come into contact with the top of the pad 54 it causes deformation to the deformable material and top-coat of the pad 54 which is in turn imaged by the camera 56 and lighting system 58 using reflected light and optical features of objects both in direct contact with said structure and beyond said structure are imaged using transmitted light. Deformable materials include various materials such as are known in the art including siloxanes such as PDMS, soft polyurethanes, etc.

The performance of the pad 58 to control optical properties which return light to the camera system enable the computer imaging system (e.g. the controller 64) to more effectively image and calculate the geometric features corresponding to the surface deformation. In the present application the surface layer is constructed to return some of the light to the camera system from the surface layer and to let some light through in such a way that the light which is returned from the surface reflective layer can be substantially differentiated from light that that is transmitted through the surface layer.

In one or more of the embodiments herein such differentially distinguishable light signals can be created through a variety of mechanisms. For instance:
light of certain spectra may be preferentially transmitted while light of other spectra is reflected;
light of certain spectra may be eliminated from the transmitted signal and light corresponding to this spectrum may be generated by the surface layer (e.g. by fluorescence);
light of certain polarization characteristics may be transmitted while light of different polarization characteristics;
scattering corrected imaging (e.g. using coherent light illumination & wavefront corrected transmission); and
time-sequential varied illumination with comparative image subtraction (e.g. blinking the internal illumination light and comparing the images produced by internal illumination on vs internal illumination off conditions).

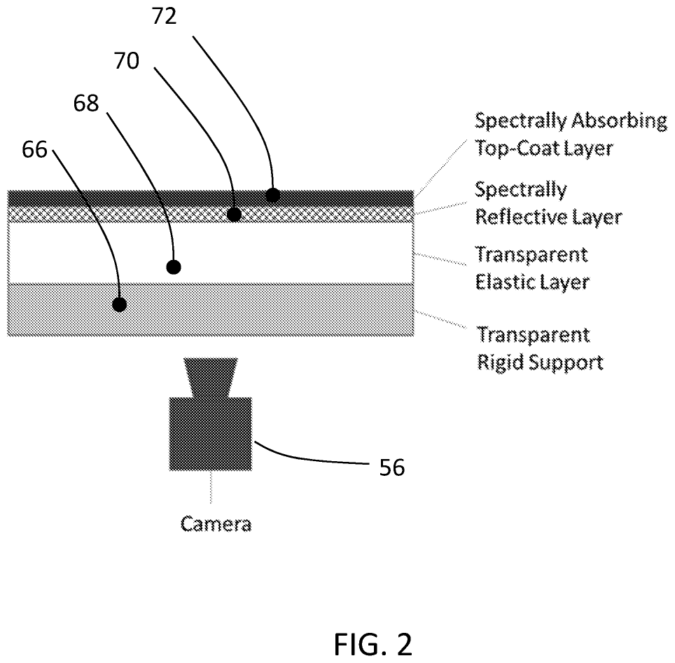

Turning now to FIG. 2, the visual-tactile contact pad 54 may be constructed in such a way that certain wavelengths of light are substantially transmitted while other wavelengths of light are substantially reflected and/or scattered back towards the camera. For instance, it is known that optical interference effects may be used to provide filtering effects which act to transmit certain wavelengths of light while transmitting other wavelengths. Such interference effects can be achieved in various ways including:
1. substantially contiguous thin-films such as are commonly used in consumer optics to form anti-reflection coatings and in optics to form wavelength selective filters
2. interference-based wavelength selective pigments which are commonly constructed as small flakes (commercially available examples include Xirallic from Merck KGaA, Iriodin from Merck Global, Pyrisma from Merck KGaA, and the like)

In embodiments disclosed herein, a layer may be included on top of the wavelength-selective reflective layer which acts to absorb some portion of the optical wavelengths which are reflected by the interference-reflective layer (e.g. a layer of dye dissolved in polymer) while allowing other wavelength spectra to pass through. This acts to enhance the spectral selectivity of such embodiments.

Embodiments disclosed herein include a rigid base 66, elastic layer 68, light layer 70, and spectrally absorbing layer 72. Although the camera 56 in FIG. 2 is shown oriented to capture a direct image of the pad 54, other embodiments can include the camera 56 displaced relative to the pad 54 and may be provided an image through reflective techniques (e.g. mirrors) or through a fiber optic cable. Such variations also apply to all other embodiments disclosed herein.

As will be understood, the term “camera” can refer to a variety of devices capable of detecting electromagnetic radiation, whether in the visible range, infrared range, etc. Such “cameras” can also refer to 2D and/or 3D cameras.

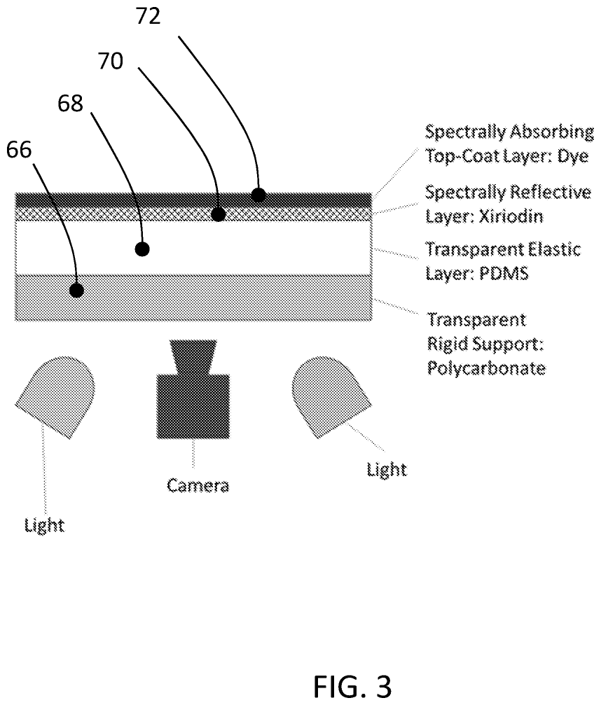

FIG. 3 depicts the sensing device 50 with a lighting system 58. Shown in FIG. 3 is the camera 56 and lighting system 58 positioned beneath the rigid base 66. In the illustrated embodiment the rigid base 66 takes the form of a hard, transparent plate of polycarbonate which supports the elastic layer 68. The rigid base 66 can take other forms as will be appreciated. The elastic layer 68 takes the form of a deformable film of polydimethylsiloxane (PDMS). The elastic layer 68 can be coated the light layer 70, which in one form is a thin (e.g. ˜5-100 um thick) layer of PDMS with entrained flakes of 158037 Xirallic T60-24 SW Stellar Green produced by Merck KGaA of Darmstadt, Germany. It is contemplated that the Xirallic flakes are oriented substantially aligned to the plane of the surface of the deformable PDMS film. The light layer 70 is in turn coated with a thin (e.g. 10 um thick) layer of dye possessing an absorption maximum substantially overlapping with the reflected light spectrum of the Xirallic flake pigment (e.g. in the green) and possessing substantially transmission characteristics in the spectrum which is not strongly reflected by the Xirallic flake (e.g. in the red portion of the spectrum) green dispersed into and immobilized into PDMS. The incorporation of the dye layer enables external green spectrum light to be substantially blocked from reaching the camera thus ensuring that green spectrum light is the result of Xirallic layer reflection and carries information relating to the surface morphology of the tactile stack (and in particular deformations of this surface). In one form the Xirallic and dye layers substantially allow red light to pass through this stack so that light in the red spectrum reaching the camera substantially corresponds to light that has passed through the stack and carries information about objects beyond the tactile stack. In this way the work piece 52 can be imaged as it approaches, but not yet touching, the visual-tactile contact pad 54.

FIG. 3 also discloses multiple lights are provided to aid in illumination of the work piece 52 and pad 54. As will be appreciated given the discussion above, the lights can be housed within the device 50. In some cases these lights may be configured in different positions to provide different lighting conditions for imaging the tactile surface and objects 52 beyond the tactile surface. In some cases these lights may be disposed to provide lighting from opposite sides of the camera so that the structure of illuminated and darkened regions (shadows) provides further information on the surface deformation. The light sources can be placed any distance away from one another and at any spacing suitable relative to the viewing window of the camera 56. The lighting sources can be arranged to project toward each other. The projection can, but need not, be at common angles. The lights can, but need not, project common intensity (lumens). The lights can, but need not, project at common wavelengths. Any variation of the above parameters (orientation, angles, lumens, wavelengths) are contemplated herein.

In some cases these lighting conditions are provided as a sequential series of illumination (e.g. blinking) provided from alternating lighting sources so that multiple lighting conditions can be utilized to maximize the processable information and the camera can obtain distinguishing light information in both spectral and temporal channels. Thus, the lights can be activated in an ON-OFF sequence which, in some forms, are coordinated with each other. To set forth just one non-limiting example, a first light can be activated to the ON condition while the second light is deactivated to the OFF condition, whereupon after an interval of time (which can be predetermined or determined as a result of system processing) the condition reversed with the first light deactivated to OFF while the second light is activated to ON. The above-described process can be repeated with the same or different interval. Such alternating can be sequences which results in a blinkering of lights.

The lighting system 58 (either a single light source or multiple light sources) can be structured to emit light (electromagnetic radiation) at a single wavelength or a range of wavelengths. As used herein the term “emit” or “emitting” or “emanate” or “emanating” is used to describe a process by which a material can either reflect light produced from another source, can produce light itself (e.g. infrared radiation if heated), or can be excited to produce light (e.g. fluorescence). To set forth just one example, a light source can be structured to emit light at a wavelength visible to a human eye (e.g. “visible light”), at infrared or near-infrared wavelengths, a combination of the same, or any other suitable wavelength(s). In some forms the lighting system can include a single light source capable of emitting any of the aforementioned wavelengths and/or ranges. In other forms multiple light sources can be used to emit light at any of the aforementioned wavelengths and/or ranges (which sources can emit at the same wavelengths and/or ranges or can overlap in at least some of the wavelengths and/or ranges). In some forms the lighting system can include an artificial light directly coupled with the imaging system described herein, as well as ambient sunlight, or any other source of light that may not be directly coupled to the imaging system described herein.

As discussed elsewhere in the present disclosure, variations of the lighting system 58 discussed with respect to FIG. 3 are also contemplated with the other embodiments.

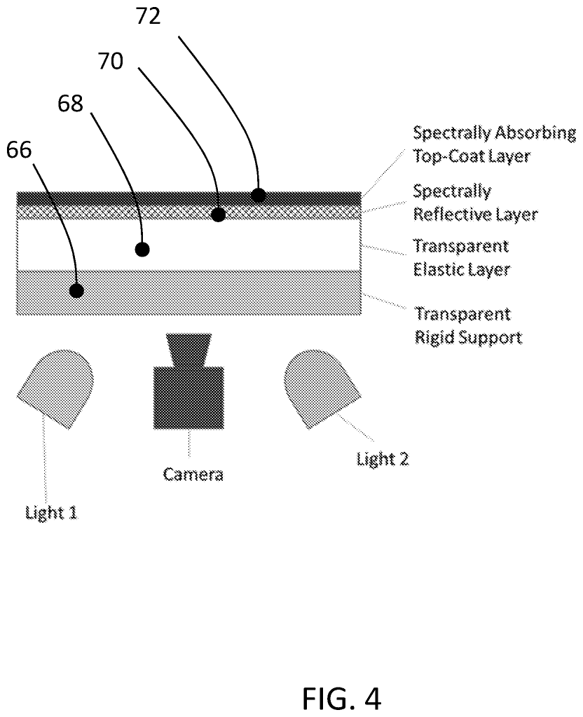

FIG. 4 discloses different compositions of the layers of the pad 54 relative to that depicted in FIG. 3.

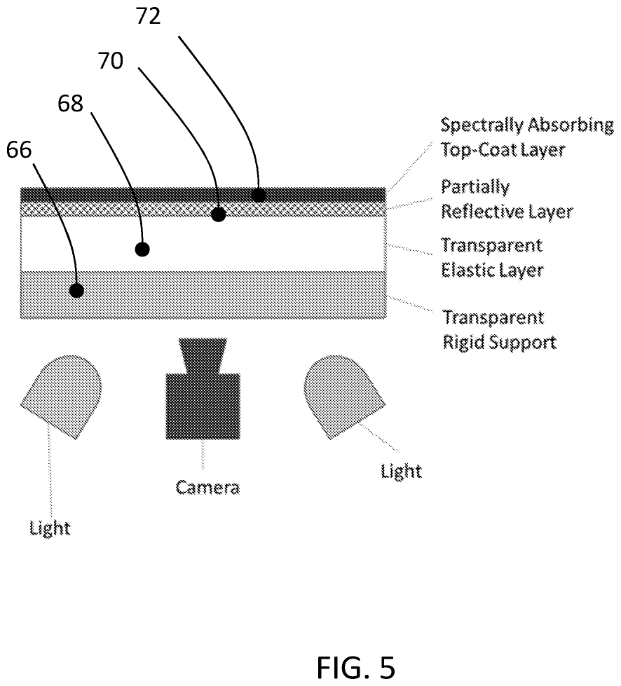

In another embodiment, FIG. 5, a surface dye layer 72 which is selective for absorbing certain parts of the spectrum imaged by the camera while transmitting others is utilized and under this layer a layer of non-selective optically scattering particles (such as nickel microparticles) which are arranged in a morphological density so that the layer provides both substantial back-reflection and also allows substantial transmission of light through this layer. In this case the reflected and transmitted light are separable according to color to distinguish between the two information channels.

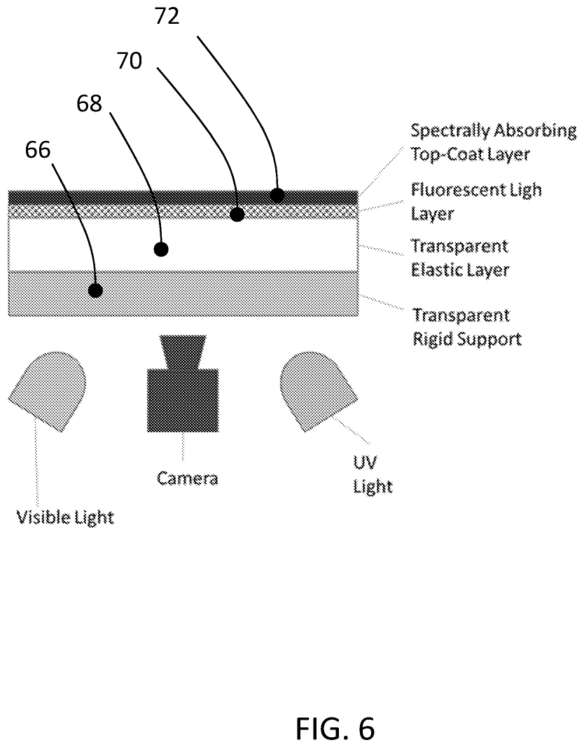

In another embodiment, FIG. 6, a surface dye layer 72 which is selective for absorbing certain parts of the spectrum imaged by the camera while transmitting others is utilized and under this layer a layer 70 containing fluorescent material which fluoresce in a particular spectrum which substantially corresponds to the some portion of the spectrum which is absorbed by the surface dye layer 72 and wherein a suitable illumination source is utilized to excite the fluorescent layer (e.g. in the UV) to provide illumination for the camera and wherein additional lighting may be provided in other wavelengths to enable the visual imaging of objects 52 beyond the dye layer 72. In this case the fluorescent and transmitted light are separable according to color to distinguish between the two information channels.

In yet another embodiment, FIG. 7, a surface or near surface a layer 70 containing fluorescent material which fluoresces and wherein a suitable illumination source 58 is utilized to excite the fluorescent layer (e.g. in the UV) to provide illumination for the camera and wherein additional lighting may be provided in other wavelengths to enable the visual imaging of objects beyond the dye layer. And wherein the illumination source is temporally modulated in a determined matter (e.g. blinked) and the differential signal between the illuminated & fluorescing state versus the non-fluorescing state is utilized to obtain information regarding surface information from the fluorescence-derived light versus light that originates from beyond the fluorescent layer. In some cases another layer is incorporated over the top of the fluorescent layer to prevent exciting light from impinging upon the fluorescent layer from above. In this case the fluorescent and transmitted light are separable according to time signature to distinguish between the two information channels. Although the lights can be activated as described above in this embodiment, it will be appreciated that any of the other embodiments may also have lights activated in this manner.

One aspect of the present application includes an apparatus comprising:
a visual tactile sensing device structured to image a work piece prior to engagement with a visual-tactile contact pad to develop work piece image data, and to image a tactile impression of the work piece upon engagement of the work piece with the visual-tactile contact pad to develop tactile image data, the visual tactile sensing device having: a lighting system structured to emit light; a camera structured to image electromagnetic radiation associated with the light emitted from the lighting system; and wherein the visual-tactile contact pad includes: a rigid base; an elastic layer coupled to the rigid base, the rigid base providing a structural support for the elastic layer; a light layer structured to receive light from the lighting system and emanate a first electromagnetic wavelength therefrom, the light layer positioned adjacent the elastic layer such that the elastic layer is positioned between the rigid base and the light layer; and a spectrally absorbing layer positioned adjacent the elastic layer such that the elastic layer is positioned between the rigid base and the spectrally absorbing layer, the spectrally absorbing layer structured to remove the first electromagnetic wavelength and permit passage of a second electromagnetic wavelength of light; wherein the elastic layer, the light layer, and the spectrally absorbing layer of the visual-tactile contact pad are structured to deform upon engagement of the work piece with the visual-tactile contact pad, wherein the tactile image data is generated from the first electromagnetic wavelength emanating from the light layer upon engagement of the work piece to the visual-contact pad, and wherein the work piece image data is generated from the second electromagnetic wavelength emanating from the work piece which passes through the spectrally absorbing layer.

A feature of the present application includes wherein the light layer is structured to reflect the first electromagnetic wavelength.

Another feature of the present application includes wherein the light layer is structured to fluoresce upon receipt of the first electromagnetic wavelength and produce a fluorescent wavelength as a result, and wherein the spectrally absorbing layer is structured to absorb the fluorescent wavelength.

Still another feature of the present application includes wherein the light system includes two light sources.

Yet feature of the present application includes wherein the two light sources are disposed on opposite sides of the camera.

Still another feature of the present application further includes a controller, and wherein the controller is structured to activate the two light sources in an alternating manner such that when a first light source of the two light sources is ON then a second light source of the two light sources is OFF, and vice versa.

Yet still another feature of the present application includes wherein the rigid base is made of a polycarbonate material, wherein the elastic layer is polydimethylsiloxane (PDMS).

Still yet another feature of the present application includes wherein the light layer is layer of PDMS with entrained flakes of Xirallic T60-24 SW Stellar Green.

A further feature of the present application includes wherein the flakes are oriented substantially aligned to the plane of the surface of the elastic layer.

A still further feature of the present application includes wherein the spectrally absorbing layer is a dye layer, and the light layer includes non-selective optically scattering particles arranged in a morphological density so that the layer provides both back-reflection and allows transmission of the second wavelength.

Another aspect of the present application includes method of operating a visual tactile sensing device, comprising: emitting a light from a lighting system toward a visual-tactile contact pad of a robotic system, the robotic system including a camera for imaging a work piece and contact of the work piece with the visual-tactile contact pad; passing the light through a rigid base and an elastic layer coupled to the rigid base of the visual-tactile contact pad; emitting a first electromagnetic wavelength from a light layer which is attached to the elastic layer and in a direction toward the camera; absorbing the first electromagnetic wavelength in a spectrally absorbing layer attached to the light layer; passing a second electromagnetic wavelength through the spectrally absorbing layer toward the camera; deforming the elastic layer, light layer, and spectrally absorbing layer upon engagement of the work piece with the visual-tactile contact pad.

A feature of the present application includes wherein the emitting includes emitting light from a first light source of the lighting system and emitting light from a second light source of the lighting system.

Another feature of the present application includes wherein the emitting a first electromagnetic wavelength is from reflecting the first electromagnetic wavelength.

Still another feature of the present application includes wherein the emitting a first electromagnetic wavelength is from fluorescing the light layer as a result of excitation wavelength from the lighting system.

Yet another feature of the present application further includes controlling the light system to selectively activate and deactivate a plurality of light sources.

Yet another aspect of the present application includes an apparatus comprising: a visual tactile sensing device structured to develop data associated with an image of a work piece and tactile contours of the work piece, the visual tactile sensing device having: a camera structured to image a first electromagnetic wavelength and a second electromagnetic wavelength; a lighting system structured to produce light at the first electromagnetic wavelength and the second electromagnetic wavelength; a visual-tactile contact pad having a layered construction and structured to deform through at least some of the layers of the layered construction when in contact with the work piece, the visual-tactile contact pad having: a rigid base; an elastic layer coupled to the rigid base; a light layer coupled to the elastic layer such that the elastic layer is between the rigid base and the light layer, the light layer structured to emanate light as a result of the first electromagnetic wavelength and according to deformations in the light layer associated with the tactile contours of the work piece when the work piece engages the visual-tactile contact pad; and a spectrally absorbing layer coupled to the light layer such that the light layer is between the elastic layer and the spectrally absorbing layer, the spectrally absorbing layer structured to pass the second electromagnetic wavelength.

A feature of the present application includes wherein the light system includes two light sources.

Another feature of the present application further includes a controller configured to alternate light emanating from the two light sources.

Yet another feature of the present application includes wherein the elastic layer contacts the rigid base and the light layer, and wherein the rigid base is made of a transparent polycarbonate material.

Still another feature of the present application includes wherein the spectrally absorbing layer is a dye layer, and wherein the spectrally absorbing layer contacts the light layer.

Yet still another feature of the present application includes wherein the light layer is entrained with flakes of Xirallic Stellar Green, and wherein the spectrally absorbing layer includes an absorption maximum substantially overlapping the reflected light spectrum of the Xirallic Stellar Green flakes and includes a transmission characteristic in the spectrum which is not reflected by the Xirallic Stellar Green flakes.

Still yet another feature of the present application includes wherein the light layer includes nickel microparticles.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

What is claimed is:

1. An apparatus comprising:
a visual tactile sensing device structured to image a work piece prior to engagement with a visual-tactile contact pad to develop work piece image data, and to image a tactile impression of the work piece upon engagement of the work piece with the visual-tactile contact pad to develop tactile image data, the visual tactile sensing device having:
a lighting system structured to emit light;
a camera structured to image electromagnetic radiation associated with the light emitted from the lighting system; and
wherein the visual-tactile contact pad includes:
a rigid base;
an elastic layer coupled to the rigid base, the rigid base providing a structural support for the elastic layer;
a light layer structured to receive light from the lighting system and emanate a first electromagnetic wavelength therefrom, the light layer positioned adjacent the elastic layer such that the elastic layer is positioned between the rigid base and the light layer; and
a spectrally absorbing layer positioned adjacent the elastic layer such that the elastic layer is positioned between the rigid base and the spectrally absorbing layer, the spectrally absorbing layer structured to remove the first electromagnetic wavelength and permit passage of a second electromagnetic wavelength of light;
wherein the elastic layer, the light layer, and the spectrally absorbing layer of the visual-tactile contact pad are structured to deform upon engagement of the work piece with the visual-tactile contact pad, wherein the tactile image data is generated from the first electromagnetic wavelength emanating from the light layer upon engagement of the work piece to the visual-contact pad, and wherein the work piece image data is generated from the second electromagnetic wavelength emanating from the work piece which passes through the spectrally absorbing layer.

2. The apparatus of claim 1, wherein the light layer is structured to reflect the first electromagnetic wavelength.

3. The apparatus of claim 1, wherein the light layer is structured to fluoresce upon receipt of the first electromagnetic wavelength and produce a fluorescent wavelength as a result, and wherein the spectrally absorbing layer is structured to absorb the fluorescent wavelength.

4. The apparatus of claim 1, wherein the light system includes two light sources.

5. The apparatus of claim 4, wherein the two light sources are disposed on opposite sides of the camera.

6. The apparatus of claim 5, which further includes a controller, and wherein the controller is structured to activate the two light sources in an alternating manner such that when a first light source of the two light sources is ON then a second light source of the two light sources is OFF, and vice versa.

7. The apparatus of claim 1, wherein the rigid base is made of a polycarbonate material, wherein the elastic layer is polydimethylsiloxane (PDMS).

8. The apparatus of claim 7, wherein the light layer is layer of PDMS with entrained flakes of Xirallic T60-24 SW Stellar Green.

9. The apparatus of claim 8, wherein the flakes are oriented substantially aligned to the plane of the surface of the elastic layer.

10. The apparatus of claim 1, wherein the spectrally absorbing layer is a dye layer, and the light layer includes non-selective optically scattering particles arranged in a morphological density so that the layer provides both back-reflection and allows transmission of the second wavelength.

11. A method of operating a visual tactile sensing device, comprising:
emitting a light from a lighting system toward a visual-tactile contact pad of a robotic system, the robotic system including a camera for imaging a work piece and contact of the work piece with the visual-tactile contact pad;
passing the light through a rigid base and an elastic layer coupled to the rigid base of the visual-tactile contact pad;
emitting a first electromagnetic wavelength from a light layer which is attached to the elastic layer and in a direction toward the camera;
absorbing the first electromagnetic wavelength in a spectrally absorbing layer attached to the light layer;
passing a second electromagnetic wavelength through the spectrally absorbing layer toward the camera;
deforming the elastic layer, light layer, and spectrally absorbing layer upon engagement of the work piece with the visual-tactile contact pad.

12. The method of claim 11, wherein the emitting includes emitting light from a first light source of the lighting system and emitting light from a second light source of the lighting system.

13. The method of claim 11, wherein the emitting a first electromagnetic wavelength is from reflecting the first electromagnetic wavelength.

14. The method of claim 11, wherein the emitting a first electromagnetic wavelength is from fluorescing the light layer as a result of excitation wavelength from the lighting system.

15. The method of claim 11, which further includes controlling the light system to selectively activate and deactivate a plurality of light sources.

16. An apparatus comprising:
a visual tactile sensing device structured to develop data associated with an image of a work piece and tactile contours of the work piece, the visual tactile sensing device having:
a camera structured to image a first electromagnetic wavelength and a second electromagnetic wavelength;
a lighting system structured to produce light at the first electromagnetic wavelength and the second electromagnetic wavelength;
a visual-tactile contact pad having a layered construction and structured to deform through at least some of the layers of the layered construction when in contact with the work piece, the visual-tactile contact pad having:
a rigid base;
an elastic layer coupled to the rigid base;
a light layer coupled to the elastic layer such that the elastic layer is between the rigid base and the light layer, the light layer structured to emanate light as a result of the first electromagnetic wavelength and according to deformations in the light layer associated with the tactile contours of the work piece when the work piece engages the visual-tactile contact pad; and
a spectrally absorbing layer coupled to the light layer such that the light layer is between the elastic layer and the spectrally absorbing layer, the spectrally absorbing layer structured to pass the second electromagnetic wavelength.

17. The apparatus of claim 16, wherein the light system includes two light sources.

18. The apparatus of claim 17, which further includes a controller configured to alternate light emanating from the two light sources.

19. The apparatus of claim 16, wherein the elastic layer contacts the rigid base and the light layer, and wherein the rigid base is made of a transparent polycarbonate material.

20. The apparatus of claim 19, wherein the spectrally absorbing layer is a dye layer, and wherein the spectrally absorbing layer contacts the light layer.

21. The apparatus of claim 19, wherein the light layer is entrained with flakes of Xirallic Stellar Green, and wherein the spectrally absorbing layer includes an absorption maximum substantially overlapping the reflected light spectrum of the Xirallic Stellar Green flakes and includes a transmission characteristic in the spectrum which is not reflected by the Xirallic Stellar Green flakes.

22. The apparatus of claim 19, wherein the light layer includes nickel microparticles.
